(19) United States
(12) Patent Application Publication
(10) Pub. No.: US 2014/0116336 A1
(43) Pub. Date: May 1, 2014

(54) SUBSTRATE PROCESS CHAMBER EXHAUST

(71) Applicant: APPLIED MATERIALS, INC., Santa Clara, CA (US)

(72) Inventors: PAUL BRILLHART, Pleasanton, CA (US); DAVID ABERLE, Milpitas, CA (US)

(73) Assignee: APPLIED MATERIALS, INC., Santa Clara, CA (US)

(21) Appl. No.: 14/051,010

(22) Filed: Oct. 10, 2013

Related U.S. Application Data
(60) Provisional application No. 61/718,865, filed on Oct. 26, 2012.

(51) Int. Cl. B05B 1/00

(52) U.S. Cl. CPC B05B 1/005
USPC 118/715; 239/548

(57) ABSTRACT

Exhaust systems for substrate process chambers are provided herein. In some embodiments, an exhaust for a process chamber configured to process a substrate having a given width may include a body having an internal cavity and an opening disposed in a first side of the body, the opening fluidly coupled to the internal cavity; a plurality of through holes disposed through a second side of the body, the plurality of through holes fluidly coupled to the internal cavity, wherein the plurality of through holes are disposed symmetrically about the body with respect to a central axis of the body such that the plurality of through holes provide an equal length and pressure drop from the opening to each respective through hole; and a plurality of conduits, each having a first open end respectively coupled to the plurality of through holes.

### CROSS-REFERENCE TO RELATED APPLICATIONS

This application claims benefit of U.S. provisional patent application Ser. No. 61/718,865, filed Oct. 26, 2012, which is herein incorporated by reference.

### FIELD

Embodiments of the present invention generally relate to semiconductor processing equipment.

### BACKGROUND

Some conventional process chambers that provide process gases laterally across a surface of a substrate to be processed utilize an exhaust port that is disposed opposite a gas supply and located in a central, or slightly off center location, to remove process gases from the process chamber. The inventors have observed that a flow field of the process gases from the gas supply to the exhaust port is non-uniform across the process chamber cross section (e.g., a “v” shaped flow field), thereby resulting in uneven distribution of process gases across a substrate disposed in the process chamber, which could lead to non-uniform process results.

Thus, the inventors have provided an improved exhaust for use with a process chamber.

### SUMMARY

Exhaust systems for substrate process chambers are provided herein. In some embodiments, an exhaust for a process chamber configured to process a substrate having a given width may include a body having an internal cavity and an opening disposed in a first side of the body, the opening fluidly coupled to the internal cavity; a plurality of through holes disposed through a second side of the body, the plurality of through holes fluidly coupled to the internal cavity, wherein the plurality of through holes are disposed symmetrically about the body with respect to a central axis of the body such that the plurality of through holes provide an equal length and pressure drop from the opening to each respective through hole; and a plurality of conduits, each having a first open end respectively coupled to the plurality of through holes. In some embodiments, the opening may have a width at least as large as the given width of the substrate.

In some embodiments, a process chamber for processing a substrate having a given width may include a chamber body having a gas inlet disposed on a first side of the chamber body and an exhaust port disposed on a second side of the chamber body, opposite the first side; a substrate support to support a substrate having a given width disposed between the gas inlet and the exhaust port; and an exhaust coupled to the exhaust port. The exhaust may include a body having an internal cavity and an opening disposed in a first side of the body, the opening fluidly coupled to the internal cavity, wherein the opening is fluidly coupled to the exhaust port, and wherein the opening and the exhaust port each have a width at least as large as the given width; a plurality of through holes disposed through a second side of the body, the plurality of through holes fluidly coupled to the internal cavity, wherein the plurality of through holes are disposed symmetrically about the body with respect to a central axis of the body; and a plurality of conduits, each having a first open end respectively coupled to the plurality of through holes.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 is an exhaust for use with a process chamber in accordance with some embodiments of the present invention.

FIG. 2 is a cross sectional view of an exhaust for use with a process chamber in accordance with some embodiments of the present invention.

FIG. 3 is a process chamber configurable for use with an exhaust in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Exhaust systems for substrate process chambers are provided herein. In some embodiments, the inventive apparatus may advantageously provide more balanced and uniform process gas flow fields over a substrate disposed in a process chamber, as compared to a flow of process gas in a process chamber utilizing a conventionally configured exhaust.

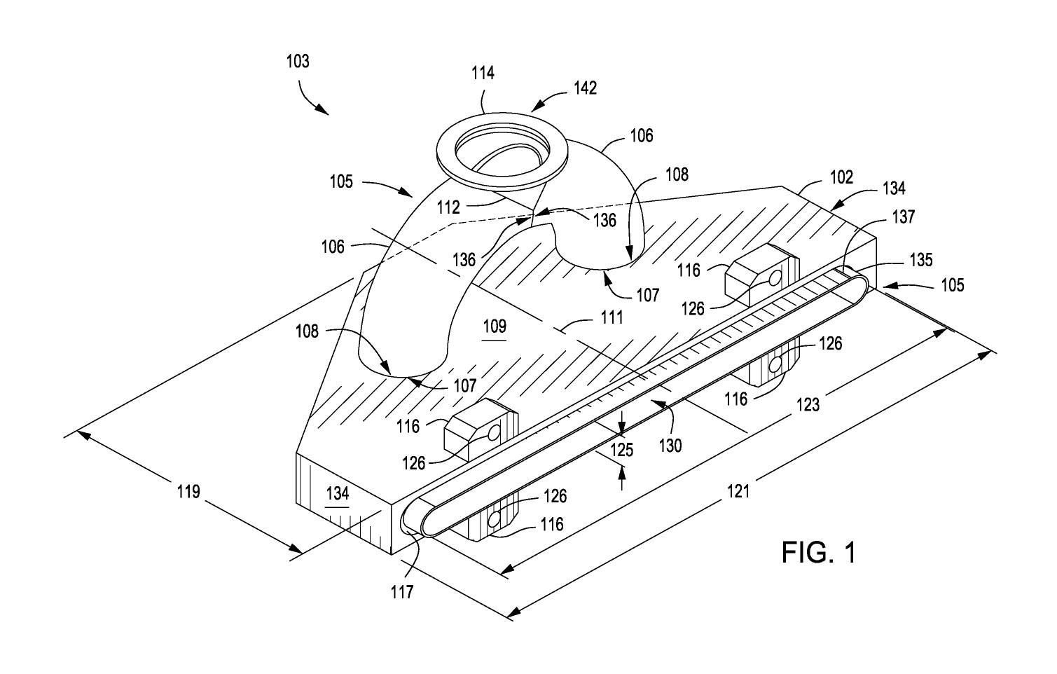

Referring to FIG. 1, in some embodiments, the exhaust 103 may generally comprise a body 102 and a plurality of conduits (two conduits 106 shown) respectively coupled to a plurality of through holes 107 disposed in the body 102.

The body 102 comprises an internal cavity 130 and an opening 135 disposed in a first side 105 of the body 102, wherein the opening 135 is fluidly coupled to the internal cavity 130. When the exhaust 103 is coupled to a process chamber (e.g., process chamber 300 described below), the opening 135 functions as an exhaust port to facilitate the removal of gases (e.g., process gases) from the process chamber via the exhaust 103.

The body 102 may generally have any shape and size sufficient to support and contain the opening 135 to facilitate uniform gas flow within the process chamber. For example, in some embodiments, the body 102 may comprise an irregular hexagon shape having symmetry about a central axis 111 of the body 102, such as shown in FIG. 1. In some embodiments, the body 102 may have an overall depth 119 of about 100 mm to about 300 mm, which varies with substrate size, or in some embodiments, about 169 mm. In some embodiments, the body 102 may have an overall width 121 of about 325 mm to about 350 mm, for example, for use with processing 300 mm wafers, or in some embodiments, up to about 600 mm for example, for use with processing 450 mm wafers. Other dimensions may be used for substrates having other dimensions, such as 200 mm wafers, etc.

In some embodiments, the opening 135 may have dimensions that are similar to a given width of a substrate disposed in the process chamber. For example, the given width may be a diameter of a circular substrate or a facing width of a rectangular or irregular-shaped substrate. As used herein, the facing width refers to a width of the substrate measured substantially parallel to the width of the opening 135. For example, in some embodiments, the opening 135 may have a width 123 of about 200 mm (for example, for use with 200 mm wafers) to about 550 mm (for example, for use with 450 mm wafers), with scaling for other size substrates. In some embodiments, the opening 135 may have a height 125 of about 5 mm to about 25 mm. For example, the size of the opening may be selected both based upon the substrate size as well as to take into consideration volume versus aspect ratio for flow boundary development.

The inventors have observed that providing the opening 135 having dimensions similar to the substrate facilitates a more constant exhaust gas pressure uniformity across the process chamber cross section, thereby resulting in more uniform process gas flow fields over the substrate as compared to a flow of process gas in a process chamber utilizing conventionally or smaller sized exhaust ports. In some embodiments, a channel 117 may be disposed about the opening. When present, the channel 117 may be configured to receive a gasket, such as an o-ring, to facilitate a vacuum seal between the exhaust 103 and the process chamber. In some embodiments, an outwardly extending protrusion 137 may be disposed about the opening 135, the outwardly extending protrusion 137 configured to interface with a feature of the process chamber (e.g. an opening in a wall of the process chamber) to facilitate a vacuum seal with the process chamber.

In some embodiments, the plurality of through holes 107 may be disposed in a second side 109 of the body 102 and fluidly coupled to the internal cavity 130. The plurality of through holes 107 provide an outlet for process gases evacuated from the process chamber via the exhaust 103. The plurality of through holes 107 may generally comprise any number of through holes disposed in any manner about the second side 109 of the body 102 suitable to provide a uniform flow of process gas across the process chamber and may be determined, for example, by the size and shape of the body 102, the process chamber, the substrate, or the like.

For example, in some embodiments, the plurality of through holes 107 may be two through holes disposed symmetrically about the body 102 with respect to a central axis 111 of the body 102, such as shown in FIG. 1. Alternatively, or in combination, the plurality of through holes 107 may be disposed such that each hole of the plurality of through holes 107 may be spaced equidistant from an adjacent sidewall 134 of the body 102 and the central axis 111 of the body 102. The inventors have observed that such a configuration facilitates flow uniformity through the exhaust 103.

Providing a plurality of through holes 107 and conduits 106 in the body facilitates providing a more even and uniform pressure across the opening 135 as compared to providing a single exhaust conduit, thereby facilitating a more uniform flow field in the process chamber. Disposing the plurality of through holes 107 and conduits 106 symmetrically about the central axis 111 of the exhaust 103 facilitates providing a more symmetric and uniform flow of process gas across the process chamber as the process gas flows from a gas inlet to the exhaust 103 of the process chamber.

In some embodiments, the plurality of conduits (two conduits 106 shown) may be respectively coupled to the plurality of through holes 107 at a first open end 108 of each of the plurality of conduits 106. The plurality of conduits 106 provide a flow path for the process gases to flow from the exhaust 103 to a vacuum source, such as a vacuum pump. Each of the plurality of conduits 106 may have any shape and dimensions suitable to provide a flow of process gas while limiting back pressure within the plurality of conduits 106. For example, in some embodiments, each of the plurality of conduits 106 may comprise a circular cross section having an inner diameter selected to be a large as possible while preventing backstreaming. For example in some embodiments, the inner diameter may be about 152 mm, although other dimensions may be used. Also, the inner diameter may be selected with consideration for the cross sectional area of adjacent portions of the exhaust to facilitate providing gradual changes in cross sectional area, which are more desirable as the pressure drop is less, turbulence is less, and there is lower deposition on the sidewalls as flow deadspots are minimized. For example, for a 300 mm wafer application, an inner diameter range of about 1.5 to about 2 inches with a main exhaust of about 2 to about 3 inches. Smaller sizes may also be used, however, they may cause a pressure restriction that limits the lowest pressure the chamber can run at.

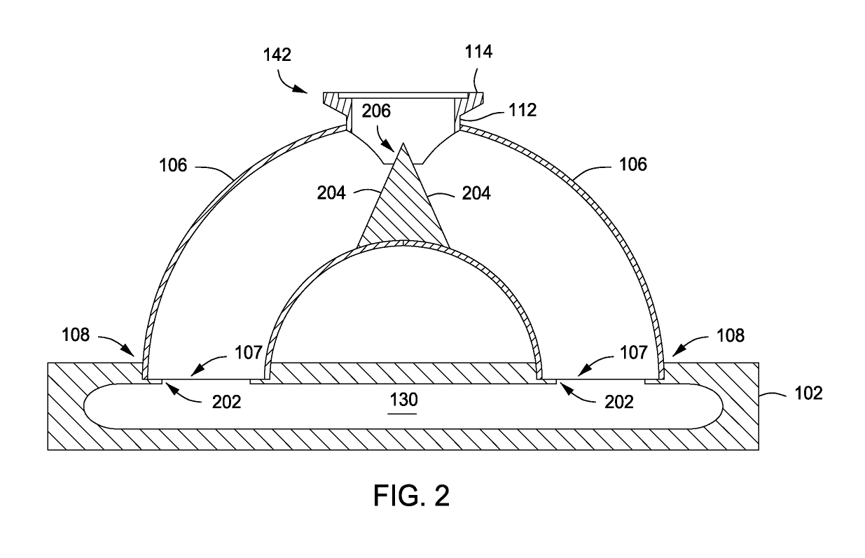

The plurality of conduits 106 may be coupled to the body 102 in any manner suitable to provide a secure coupling of the plurality of conduits 106 to the body 102, for example such as welding, bolting, press fitting, or the like. In some embodiments, each through hole of the plurality of through holes 107 may comprise an inwardly facing ledge 202 configured to support the first open end 108 of each of the plurality of conduits 106 to facilitate coupling the plurality of conduits 106 to the body 102, for example, such as shown in FIG. 2.

For anti-reversion (i.e., preventing backstreaming of particles), a reverse flow restriction may be provided. For example, in some embodiments, the inwardly facing ledges 202 may define the hole 107 to be smaller than that of the inner diameter of the plurality of conduits 106, thereby providing a reverse flow restriction that facilitates prevention of particle backstreaming. Other flow restrictions can be used alternatively or in combination. For example, the plurality of conduits 106 can be coupled to a top surface of the body 102 over the holes 107, rather than on the inwardly facing ledges 202, where the holes 107 are smaller than the inner diameter of the plurality of conduits 106. Alternatively or in combination, an insert may be provided in the opening or in the plurality of conduits 106 to provide such a flow restriction.

In some embodiments, the plurality of conduits 106 may be coupled to one another at a second end 136 of each of the plurality of conduits 106. In some embodiments, the plurality of conduits 106 may have, or may be coupled to, a common opening to facilitate coupling the plurality of conduits 106 to a vacuum pump. For example, in some embodiments, a secondary conduit 112 may be coupled to the second ends 136 of the plurality of conduits 106 to facilitate coupling the exhaust 103 to a single inlet of a vacuum pump. In some embodiments, an outwardly extending end 142 of the secondary conduit 112 may comprise a flange 114 (e.g., a quick flange, Klein flange, or the like) to facilitate coupling the secondary conduit 112 to an inlet of a vacuum pump.

In some embodiments, a flow control block 206 may be provided within the conduits 106 at their junction with the secondary conduit 112. The flow control block 206 has angled walls 204 to help the transition from two conduits to the single conduit (e.g., from conduits 106 to secondary conduit 112). Providing the flow control block 206 facilitates smoothing flow and pressure between the conduits 106 and the secondary conduit 112.

In some embodiments, the exhaust 103 may be configured as a modular bolt-on component, thus allowing it to be utilized with pre-existing process chambers without the need to make substantial modifications to the process chamber. For example, in some embodiments, the body 102 may comprise a plurality of tabs or other features (four tabs 116 shown) extending outwardly from the body 102 to facilitate coupling the exhaust 103 to a process chamber. Each of the plurality of tabs 116 may include a through hole 126 configured to interface with a fastener (e.g., bolt, screw, or the like) to facilitate coupling the exhaust 103 to a process chamber. Alternatively or in combination, the exhaust 103 may be coupled to the process chamber in other suitable ways, such as by clamping or the like.

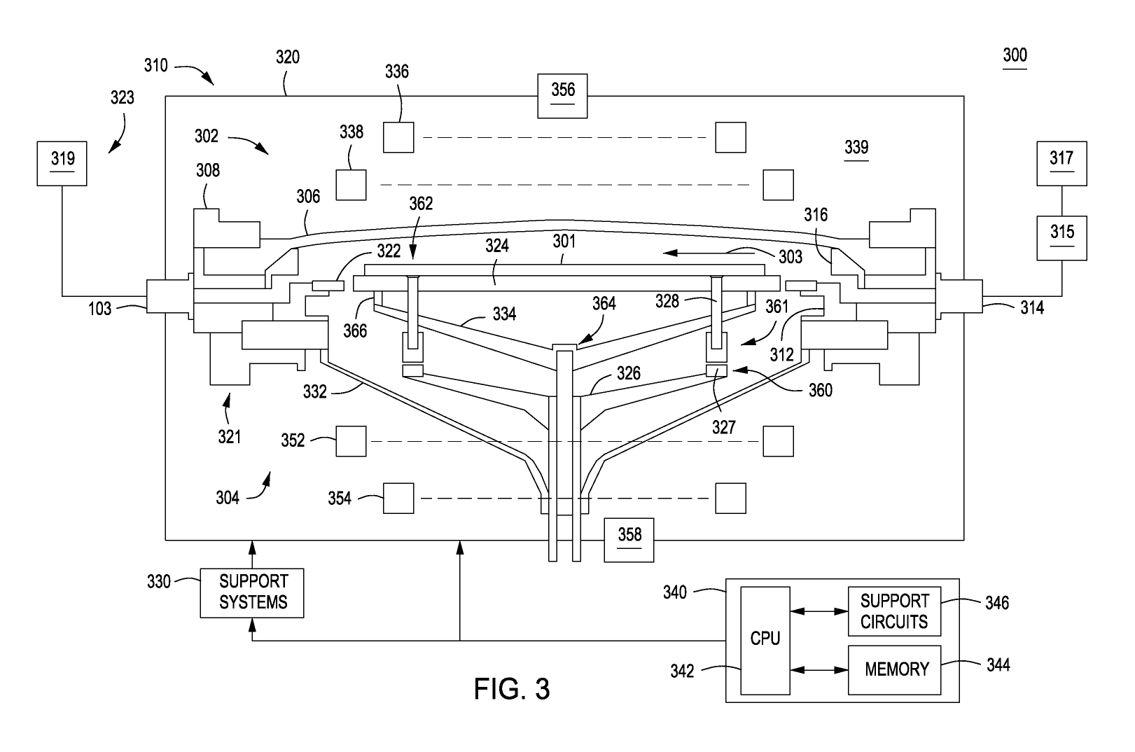

Embodiments of the inventive apparatus disclosed herein may be used in any suitable process chamber, including those adapted for performing epitaxial deposition processes, such as the RP EPI reactor, available from Applied Materials, Inc. of Santa Clara, Calif. An exemplary process chamber is described below with respect to FIG. 3, which depicts a schematic, cross-sectional view of a process chamber 300 suitable for use with the inventive exhaust in accordance with some embodiments of the present invention. The process chamber depicted in FIG. 3 is illustrative only and the present inventive apparatus may be used to advantage in other process chambers as well, including those configured for processes other than epitaxial deposition processes, for example, rapid thermal processes (RTP).

In some embodiments, the process chamber 300 generally comprises a chamber body 310 defining an inner volume 339, support systems 330, and a controller 340. The chamber body 310 generally includes an upper portion 302, a lower portion 304, and an enclosure 320.

The upper portion 302 is disposed on the lower portion 304 and includes a lid 306, a clamp ring 308, an upper liner 316, one or more optional upper heating lamps 336 and one or more lower heating lamps 338, and an upper pyrometer 356. In some embodiments, the lid 306 has a dome-like form factor, however, lids having other form factors (e.g., flat or reverse curve lids) are also contemplated.

The lower portion 304 is coupled to a gas intake port 314 and the exhaust 103 (described above) and comprises a baseplate assembly 321, a lower dome 332, a lower liner 312, a substrate support 324, a pre-heat ring 322, a substrate lift assembly 360, a substrate support assembly 364, one or more upper heating lamps 352 and one or more lower heating lamps 354, and a lower pyrometer 358. Although the term “ring” is used to describe certain components of the process chamber 300, such as the pre-heat ring 322, it is contemplated that the shape of these components need not be circular and may include any shape, including but not limited to, rectangles, polygons, ovals, and the like.

A gas source 317 may be coupled to the chamber body 310 to provide one or more process gases to the process chamber 300 via the gas intake port 314. In some embodiments, a purifier 315 may be coupled to the gas source 317 to filter or purify the one or more process gases prior to entering the chamber body 310.

The exhaust 103 (described above) is fluidly coupled to the inner volume 339 and is disposed opposite the gas intake port 314 to facilitate the removal of process gases from the process chamber 300. Thus, the process gases flow from the gas intake port 314 and across the substrate 301 to the exhaust 103 (as indicated by arrow 303).

In some embodiments, a vacuum system 323 may be coupled to the chamber body 310 via the exhaust 103 to facilitate the removal of the process gases and/or maintaining a desired pressure within the chamber body 310. In some embodiments, the vacuum system 323 may comprise a throttle valve (not shown) and vacuum pump 319. In such embodiments, the pressure inside the chamber body 310 may be regulated by adjusting the throttle valve and/or vacuum pump 319.

During processing, the substrate 301 is disposed on the substrate support 324. The heating lamps 336, 338, 352, and 354 are sources of infrared (IR) radiation (i.e., heat) and, in operation, generate a pre-determined temperature distribution across the substrate 301. The lid 306, the upper liner 316, the lower liner 312, and the lower dome 332 are formed from quartz; however, other IR-transparent and process compatible materials may also be used to form these components.

The substrate support assembly 364 generally includes a support bracket 334 having a plurality of support pins 366 coupled to the substrate support 324. The substrate lift assembly 360 comprises a substrate lift shaft 326 and a plurality of lift pin modules 361 selectively resting on respective pads 327 of the substrate lift shaft 326. In some embodiments, a lift pin module 361 comprises an optional upper portion of the lift pin 328 that is movably disposed through a first opening 362 in the substrate support 324. In operation, the substrate lift shaft 326 is moved to engage the lift pins 328. When engaged, the lift pins 328 may raise the substrate 301 above the substrate support 324 or lower the substrate 301 onto the substrate support 324.

The support systems 330 include components used to execute and monitor pre-determined processes (e.g., growing epitaxial films) in the process chamber 300. Such components generally include various sub-systems (e.g., gas panel(s), gas distribution conduits, vacuum and exhaust sub-systems, and the like) and devices (e.g., power supplies, process control instruments, and the like) of the process chamber 300. These components are well known to those skilled in the art and are omitted from the drawings for clarity.

The controller 340 may be provided and coupled to the process chamber 300 for controlling the components of the process chamber 300. The controller 340 may be any suitable controller for controlling the operation of a substrate process chamber. The controller 340 generally comprises a Central Processing Unit (CPU) 342, a memory 344, and support circuits 346 and is coupled to and controls the process chamber 300 and support systems 330, directly (as shown in FIG. 3) or, alternatively, via computers (or controllers) associated with the process chamber and/or the support systems.

The CPU 342 may be any form of a general purpose computer processor that can be used in an industrial setting. The support circuits 346 are coupled to the CPU 342 and may comprise cache, clock circuits, input/output subsystems, power supplies, and the like. Software routines, such as the methods for processing substrates disclosed herein may be stored in the memory 344 of the controller 340. The software routines, when executed by the CPU 342, transform the CPU 342 into a specific purpose computer (controller) 340. The software routines may also be stored and/or executed by a second controller (not shown) that is located remotely from the controller 340. Alternatively or in combination, in some embodiments, for example where the process chamber 300 is part of a multi-chamber processing system, each process chamber of the multi-chamber processing system may have its own controller for controlling portions of the inventive methods disclosed herein that may be performed in that particular process chamber. In such embodiments, the individual controllers may be configured similar to the controller 340 and may be coupled to the controller 340 to synchronize operation of the process chamber 300.

Thus, exhaust systems for substrate process chambers have been provided herein. While the foregoing is directed to embodiments of the present invention, other and further embodiments of the invention may be devised without departing from the basic scope thereof.

1. An exhaust for a process chamber to process a substrate having a given width, comprising:
a body having an internal cavity and an opening disposed in a first side of the body, the opening fluidly coupled to the internal cavity;
a plurality of through holes disposed through a second side of the body, the plurality of through holes fluidly coupled to the internal cavity, wherein the plurality of through holes are disposed symmetrically about the body with respect to a central axis of the body such that the plurality of through holes provide an equal length and pressure drop from the opening to each respective through hole; and
a plurality of conduits, each having a first open end respectively coupled to the plurality of through holes.

2. The exhaust of claim 1, wherein the plurality of through holes are disposed about the second side of the body such that each hole of the plurality of through holes is spaced equidistant from an adjacent sidewall of the body and the central axis of the body to facilitate flow uniformity through the exhaust.

3. The exhaust of claim 1, wherein the plurality of conduits are fluidly coupled to one another at a second end of each of the plurality of conduits, the second end opposite the first open end.

4. The exhaust of claim 3, further comprising:
a secondary conduit coupled to the second end of the plurality of conduits.

5. The exhaust of claim 4, wherein the secondary conduit is coupled to a vacuum source.

6. The exhaust of claim 1, wherein the exhaust is coupled to a process chamber such that the first opening is fluidly coupled to an inner volume of the process chamber.

7. The exhaust of claim 6, wherein the process chamber is an epitaxial deposition process chamber or a rapid thermal process chamber.

8. The exhaust of claim 6, wherein the exhaust is coupled to the process chamber on a first side of the process chamber, and wherein the process chamber comprises a gas inlet disposed on a second side of the process chamber opposite the first side and a substrate support for supporting the substrate disposed between the first side and the second side.

9. The exhaust of claim 1, wherein the opening has a width at least as large as the given width of the substrate.

10. The exhaust of claim 1, further comprising:
an outwardly extending protrusion disposed about the opening to interface with a feature formed in a portion of the process chamber to facilitate coupling the exhaust to the process chamber.

11. The exhaust of claim 1, further comprising:
a channel disposed about opening to receive a gasket to form a seal.

12. The exhaust of claim 1, further comprising:
a plurality of through holes to interface with a respective fastener to couple the exhaust to a process chamber.

13. The exhaust of claim 1, wherein each of the plurality of through holes comprise an inwardly facing ledge to support the first open end of each of the plurality of conduits.

14. A process chamber for processing a substrate having a given width, comprising:
a chamber body having a gas inlet disposed on a first side of the chamber body and an exhaust port disposed on a second side of the chamber body, opposite the first side;
a substrate support to support a substrate having a given width disposed between the gas inlet and the exhaust port; and
an exhaust coupled to the exhaust port, the exhaust comprising:
a body having an internal cavity and an opening disposed in a first side of the body, the opening fluidly coupled to the internal cavity, wherein the opening is fluidly coupled to the exhaust port, and wherein the opening and the exhaust port each have a width at least as large as the given width;
a plurality of through holes disposed through a second side of the body, the plurality of through holes fluidly coupled to the internal cavity, wherein the plurality of through holes are disposed symmetrically about the body with respect to a central axis of the body; and
a plurality of conduits, each having a first open end respectively coupled to the plurality of through holes.

15. The process chamber of claim 14, wherein the plurality of through holes are disposed about the second side of the body such that each hole of the plurality of through holes is spaced equidistant from an adjacent sidewall of the body and the central axis of the body to facilitate flow uniformity through the exhaust.

16. The process chamber of claim 14, wherein the plurality of conduits are fluidly coupled to one another at a second end of each of the plurality of conduits, the second end opposite the first open end.

17. The process chamber of claim 16, further comprising:
a secondary conduit coupled to the second end of the plurality of conduits.

18. The process chamber of claim 14, wherein the exhaust further comprises:
a plurality of tabs extending outwardly from the body, wherein each of the plurality of tabs has a through hole to interface with a fastener to facilitate coupling the exhaust to the process chamber.

19. The process chamber of claim 14, wherein each of the plurality of through holes comprise an inwardly facing ledge to support the first open end of each of the plurality of conduits.

20. The process chamber of claim 14, wherein the process chamber is an epitaxial deposition process chamber or a rapid thermal process chamber.
